(19) United States
(12) Patent Application Publication
(10) Pub. No.: US 2020/0055561 A1
(43) Pub. Date: Feb. 20, 2020

(54) MOTOR VEHICLE CONTROL SYSTEM

(71) Applicant: Alexy Cherkashov, MISSISSAUGA ON (CA)

(72) Inventor: Alexy Cherkashov, MISSISSAUGA ON (CA)

(21) Appl. No.: 16/112,449

(22) Filed: Aug. 24, 2018

(30) Foreign Application Priority Data
Aug. 15, 2018 (CA) 3014190

(51) Int. Cl. B62K 11/14; B62K 23/08; B62K 23/04; B62L 3/04; B62J 99/00; B62L 3/08; B62J 6/00

(52) U.S. Cl. CPC B62K 11/14; B62K 23/08; B62K 23/04; B62J 6/005; B62J 99/00; B62L 3/08; B62L 3/04

(57) ABSTRACT

A motor vehicle control system including a foot control assembly having a left-side foot control and a right-side foot control, and a hand control assembly having a left-side hand control and a right-side hand control. The left-side foot control is in communication with a left-signal and the right-side foot control is in communication with a right-signal and configured to control brake functions. The left-side hand control includes a clutch twist and the right-side hand control includes a throttle twist. The clutch twist configured to control a clutch when a twisting motion is applied, and the throttle twist is configured to control a throttle when the twisting motion is applied by the user. The foot control assembly and the hand control assembly are configured to be used in combination for operating a motor vehicle.

### BACKGROUND OF THE INVENTION

This application claims benefit under 35 USC 119 to Canada National Application No. 3,014,190 filed on Aug. 15, 2018 the disclosure of which is incorporated herein by reference in its entirety. The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of motor vehicles of existing art and more specifically relates to motor vehicle controlling means for motorcycles.

### RELATED ART

Motorcycles are used mostly for recreation, as a lifestyle accessory. Beyond being a mode of motor transportation or sport, motorcycling has become a subculture and lifestyle. Although mainly a solo activity, motorcycling can be social and motorcyclists tend to have a sense of community with each other. For people with disabilities it is difficult to enjoy motorcycles or other motorized recreational vehicles. For many years tools have been developed to make it possible for disabled people to do things that they may have lost from birth, by accident, or aging. A suitable solution to allow disabled users to ergonomically and comfortably operate motor vehicles is desired.

U.S. Pat. No. 5,013,326 to Eduard Horvath relates to an artificial hand. The described artificial hand includes an artificial hand which has its finger gripper swingable about an axis which includes an angle of 30° to 70° with a plane normal to axis of a prosthesis connector and its fingers inclined at an acute angle to the finger carrier to provide a more natural orientation of the hand for picking up objects at pick-up surfaces located above a support surface for the object.

### SUMMARY OF THE INVENTION

In view of the foregoing disadvantages inherent in the known motor vehicle art, the present disclosure provides a novel motor vehicle control system. The general purpose of the present disclosure, which will be described subsequently in greater detail, is to provide a system for users with disabilities of one or both wrists with an alternative means for controlling a motor vehicle.

A motor vehicle control system is disclosed herein. The motor vehicle control system includes a foot control assembly having a left-side foot control and a right-side foot control, and a hand control assembly having a left-side hand control and a right-side hand control. The left-side foot control is in communication with a left-signal and is configured to control the left-signal. The right-side foot control is in communication with a right-signal and is configured to control the right-signal. The left-side hand control includes a clutch twist and the right-side hand control includes a throttle twist, the clutch twist configured to control a clutch of a motor vehicle when a twisting motion is applied by a left-hand of a user and the throttle twist is configured to control a throttle of the motor vehicle when the twisting motion is applied by a right-hand of the user. The right-side foot control is configured to control braking when pressure is applied thereto. The foot control assembly and the hand control assembly are configured to be used in combination for operating a motor vehicle such as a motorcycle, trike, snowmobile, or ATV.

A kit is also disclosed herein including a set of instructions, the foot control assembly having the left-side foot control, and the right-side foot control, and the hand control assembly having the left-side hand control and the right-side hand control.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a motor vehicle control system, constructed and operative according to the teachings of the present disclosure.

FIG. 1 is a perspective view of the motor vehicle control system during an ‘in-use’ condition, according to an embodiment of the disclosure.

FIG. 2 is a perspective view of the motor vehicle control system of FIG. 1, according to an embodiment of the present disclosure.

FIG. 3 is a perspective view of the motor vehicle control system of FIG. 1, according to an embodiment of the present disclosure.

FIG. 4 is a perspective view of the motor vehicle control system of FIG. 1, according to an embodiment of the present disclosure.

FIG. 5 is a perspective view of the motor vehicle control system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a motor vehicle and more particularly to motor vehicle controlling means as used to improve the use of motorcycle controls for riders with disabilities of up to two wrists.

Generally, the motor vehicle control system allows a rider without full functional use of either wrist to control a motorcycle, ATV, snowmobile, bike with manual gear box. The motor vehicle control system is designed to fit sports bike, cruiser motorcycle and similar fitting different scenarios of riders' body in normal riding as well as in an emergency situations where precise control is required. The rider's arms remain in flexible connection at the handlebar ends, yet in accurate control of clutch and throttle using forearm torsion. Heel control switches are used for controlling turn signals. A hybrid foot brake uses standard downward motion for rear brake and inward toe-action side press for front break.

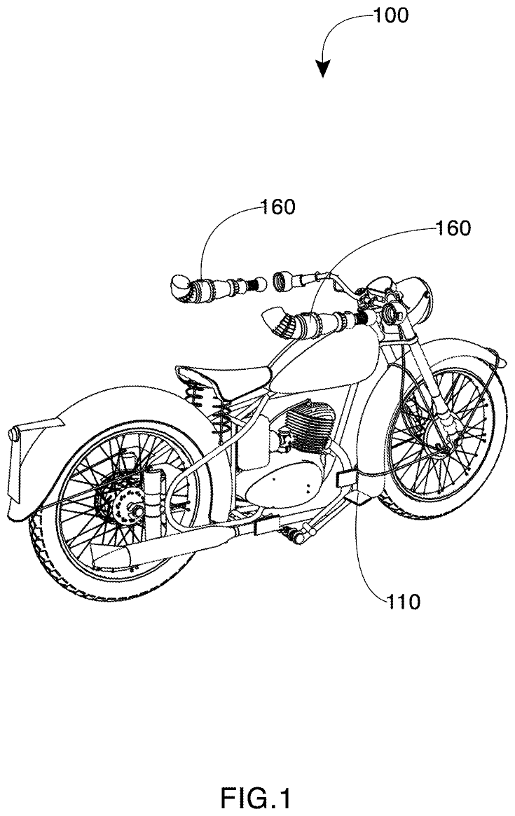

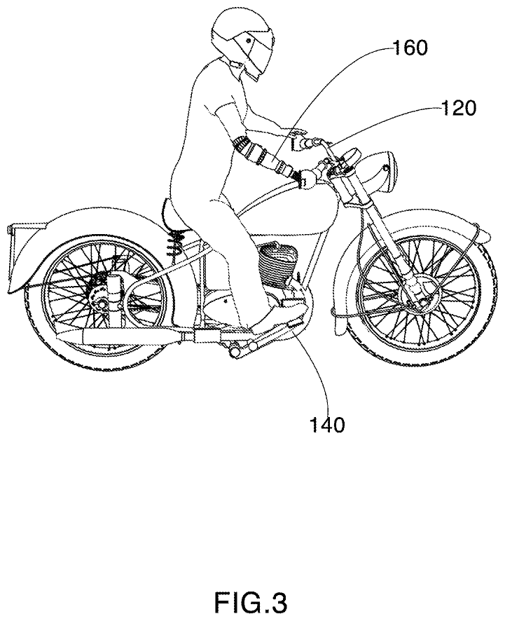

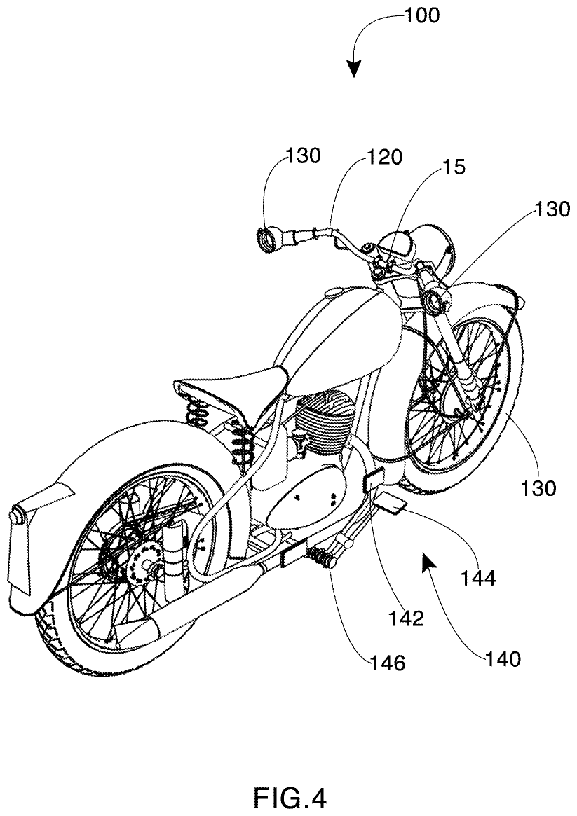

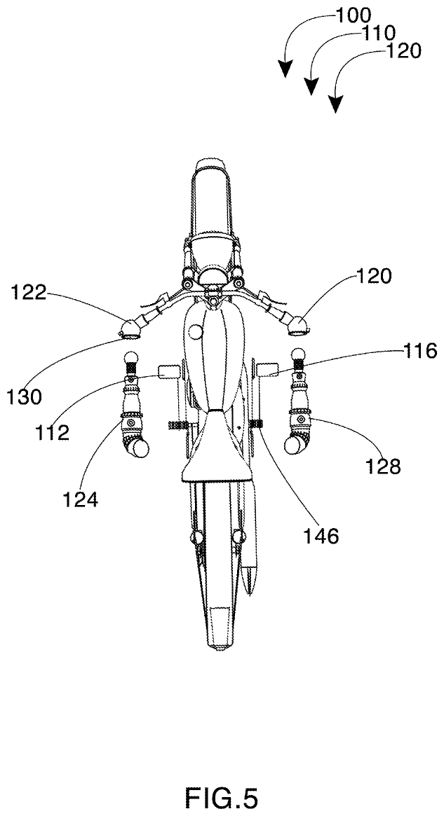

Referring now more specifically to the drawings by numerals of reference, there is shown in FIGS. 1-5, various views of a motor vehicle control system 100. FIG. 1 shows a motor vehicle control system 100 during an ‘in-use’ condition 50, according to an embodiment of the present disclosure. Here, the motor vehicle control system 100 may be beneficial for use by a user to drive and control a motor vehicle 10 with ease. As illustrated, the motor vehicle control system 100 may include a foot control assembly 110 having a left-side foot control 112 and a right-side foot control 116, and a hand control assembly 120 having a left-side hand control 122 and a right-side hand control 126.

The left-side foot control 112 is in communication with a left-signal and is configured to control the left-signal. The right-side foot control 116 is in communication with a right-signal and is configured to control the right-signal. Simultaneous action of foot controls cancels and operates high beam. The left-side hand control 122 includes a clutch twist 124 and the right-side hand control 126 includes a throttle twist 128. The clutch twist 124 is configured to control a clutch of a motor vehicle 10 when a twisting motion is applied by a left-hand of a user and the throttle twist 128 is configured to control a throttle of the motor vehicle 10 when the twisting motion is applied by a right-hand of the user. The right-side foot control 116 is configured to control braking when pressure is applied thereto. The foot control assembly 110 and the hand control assembly 120 are configured to be used in combination for operating a motor vehicle 10 such as a motorcycle, trike, snowmobile, ATV, electric motorcycle, e-bike, moped, or scooter.

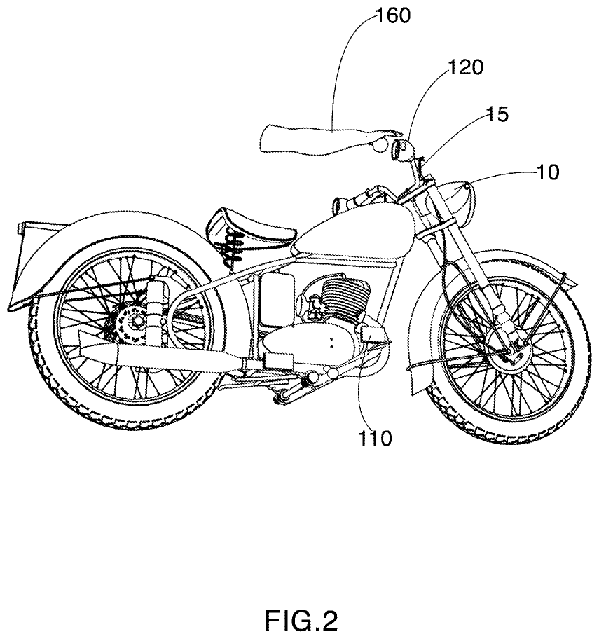

Referring now to FIG. 2-5 showing various views of the motor vehicle control system 100 including the foot control assembly 110 having the left-side foot control 112 and the right-side foot control 116, and the hand control assembly 120 having the left-side hand control 122 and the right-side hand control 126. The foot control assembly 110 and the hand control assembly 120 are configured to provide control of the motor vehicle 10 for a user having a wrist disability.

The left-side hand control 122 and the right-side hand control 126 each include a return spring action mechanism configured to allow for rotation and alternatively recoil of the left-side hand control 122 and the right-side hand control 126. The clutch twist 124 and throttle twist 128 are controlled via forearm torsion/external rotation in opposing directions. A prosthetic arm/hand may be used in conjunction with the hand control assembly 120 to control a motor vehicle 10. The forearm torsion is used to engage and control the clutch and the throttle via a modified CV-joint connected to handlebar 15. The handlebar 15 further includes an end receiver C-joint allowing flexion but controlling torsion. The left-side hand control 122 and the right-side hand control 126 each further include ball joints 130 configured to receive the clutch twist 124 and the throttle twist 128 respectively. The ball joints 130 further comprise splines. The right-side hand control 126 further includes an engine kill switch. The engine kill switch disables ignition when the right-side hand control 126 is not in the respective ball joint 130. The left-side hand control 122 features starter function, when clutch is disengaged fully for more than 4 seconds. The left-side hand control 122 and the right-side hand control 126 further include emergency auto-release spring. The emergency auto-release spring is relative and adjusted to a body weight of the user. Standard intentional release of the c-joint is performed by turning the prosthetics in opposing directions.

The foot control assembly 110 further comprises a pedal assembly 140. The foot control assembly 110 is in communication with a front brake and rear brake via anti-lock brake control module. If applicable to a motorcycle, a first-pedal 142 is configured to control the front brake when pressure is applied with an inward motion of a right toe. A second-pedal 144 is configured to control the rear brake when pressure is applied with a downward motion. The foot, signal, and light control (standard on all motorcycles) assembly further includes at least one heel contact switch 146. The at least one heel contact switch 146 is configured to control the left-signal and the right-signal on respective sides. Roll-back assist brake will be engaged by an upward motion applied to the second-pedal 144. Percentage of use will be adjusted to weight of a rider and luggage, etc.

According to one embodiment, the motor vehicle control system 100 may be arranged as a kit connected to existing electrical, hydraulic and cable-operated units. In particular, the motor vehicle control system 100 may further include a set of instructions, the foot control assembly 110 having the left-side foot control 112, and the right-side foot control 116, and the hand control assembly 120 having the left-side hand control 122 and the right-side hand control 126. The instructions may detail functional relationships in relation to the structure of the motor vehicle control system 100 such that the motor vehicle control system 100 can be used, maintained, or the like, in a preferred manner. The device may or may not be used with prosthetic devices.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A motor vehicle control system comprising:
a foot control assembly having;
a left-side foot control; and
a right-side foot control;
a hand control assembly having;
a left-side hand control; and
a right-side hand control;
wherein said left-side foot control is in communication with a left-signal and is configured to control said left-signal;
wherein said right-side foot control is in communication with a right-signal and is configured to control said right-signal;
wherein said left-side hand control includes a clutch twist and said right-side hand control includes a throttle twist, said clutch twist configured to control a clutch of a motor vehicle when a twisting motion is applied by a left-hand of a user and said throttle twist is configured to control a throttle of said motor vehicle when said twisting motion is applied by a right-hand of said user;
wherein said right-side foot control is configured to control braking when pressure is applied thereto; and
wherein said foot control assembly and said hand control assembly are configured to be used in combination for operating a motor vehicle.

2. The motor vehicle control system of claim 1, wherein the motor vehicle includes a motorcycle.

3. The motor vehicle control system of claim 1, wherein the left-side hand control and said right-side hand control each include a return spring action mechanism configured to allow for rotation and alternatively recoil of said left-side hand control and said right-side hand control.

4. The motor vehicle control system of claim 3, wherein the clutch twist and throttle twist are controlled via forearm torsion.

5. The motor vehicle control system of claim 4, wherein the forearm torsion includes external rotation.

6. The motor vehicle control system of claim 1, wherein the left-side hand control and said right-side hand control each further include ball joints configured to receive said clutch twist and said throttle twist respectively.

7. The motor vehicle control system of claim 6, wherein the ball joints further comprise splines.

8. The motor vehicle control system of claim 1, wherein the right-side hand control further includes an engine kill switch.

9. The motor vehicle control system of claim 1, wherein the left-side hand control and said right-side hand control further include emergency auto-release spring.

10. The motor vehicle control system of claim 10, wherein the emergency auto-release spring is relative and adjusted to a body weight of said user.

11. The motor vehicle control system of claim 1, wherein the foot control assembly further comprises a pedal assembly.

12. The motor vehicle control system of claim 11, wherein the foot control assembly is in communication with a front brake and rear brake via anti-lock brake control module.

13. The motor vehicle control system of claim 12, wherein a first-pedal is configured to control said front brake when pressure is applied with an inward motion.

14. The motor vehicle control system of claim 12, wherein a second-pedal is configured to control said rear brake when pressure is applied with a forward motion.

15. The motor vehicle control system of claim 1, wherein the foot control assembly further includes at least one heel contact switch.

16. The motor vehicle control system of claim 15, wherein the at least one heel contact switch is configured to control said left-signal and said right-signal on respective sides.

17. The motor vehicle control system of claim 1, wherein the hand control assembly further includes a u-joint connection to a handlebar of said motor vehicle.

18. The motor vehicle control system of claim 1, wherein the foot control assembly and said hand control assembly are configured to provide control of said motor vehicle for said user having a wrist disability.

19. A motor vehicle control system, the motor vehicle control system comprising:
a foot control assembly having;
a left-side foot control; and
a right-side foot control;
a hand control assembly having;
a left-side hand control; and
a right-side hand control;
wherein said left-side foot control is in communication with a left-signal and is configured to control said left-signal;
wherein said right-side foot control is in communication with a right-signal and is configured to control said right-signal;
wherein said left-side hand control includes a clutch twist and said right-side hand control includes a throttle twist, said clutch twist configured to control a clutch of a motor vehicle when a twisting motion is applied by a left-hand of a user and said throttle twist is configured to control a throttle of said motor vehicle when said twisting motion is applied by a right-hand of said user;
wherein said right-side foot control is configured to control braking when pressure is applied thereto;
wherein said foot control assembly and said hand control assembly are configured to be used in combination for operating a motor vehicle;
wherein the motor vehicle includes a motorcycle;
wherein the left-side hand control and said right-side hand control each include a return spring action mechanism configured to allow for rotation and alternatively recoil of said left-side hand control and said right-side hand control;
wherein the left-side hand control further includes an engine starter;
wherein the clutch twist and throttle twist are controlled via forearm torsion;
wherein the forearm torsion includes external rotation;
wherein the left-side hand control and said right-side hand control each further include ball joints configured to receive said clutch twist and said throttle twist respectively;
wherein the ball joints further comprise splines;
wherein the right-side hand control further includes an engine kill switch;
wherein the left-side hand control and said right-side hand control further include emergency auto-release spring;
wherein the emergency auto-release spring is relative and adjusted to a body weight of said user;
wherein the foot control assembly further comprises a pedal assembly;
wherein the foot control assembly is in communication with a front brake and rear brake via anti-lock brake control module;
wherein a first-pedal is configured to control said front brake when pressure is applied with an inward motion;
wherein a second-pedal is configured to control said rear brake when pressure is applied with a forward motion;
wherein the foot control assembly further includes at least one heel contact switch;
wherein the at least one heel contact switch is configured to control said left-signal and said right-signal on respective sides;
wherein the hand control assembly further includes a u-joint connection to a handlebar of said motor vehicle; and
wherein the foot control assembly and said hand control assembly are configured to provide control of said motor vehicle for said user having a wrist disability.

20. The motor vehicle control system of claim 19, further comprising:
a set of instructions;
said foot control assembly having;
said left-side foot control; and
said right-side foot control;
said hand control assembly having;
said left-side hand control; and
said right-side hand control;
wherein the motor vehicle control system is arranged as a kit.
